(19) United States
(12) Patent Application Publication
(10) Pub. No.: US 2025/0063494 A1
(43) Pub. Date: Feb. 20, 2025

(54) DAS POWER REDUCTION SCHEDULER

(71) Applicant: Outdoor Wireless Networks LLC, Claremont, NC (US)

(72) Inventor: Van Erick Hanson, Forest, VA (US)

(73) Assignee: Outdoor Wireless Networks LLC, Claremont, NC (US)

(21) Appl. No.: 18/770,124

(22) Filed: Jul. 11, 2024

Related U.S. Application Data
(60) Provisional application No. 63/520,235, filed on Aug. 17, 2023.

(51) Int. Cl. H04W 52/02; H04B 7/022

(52) U.S. Cl. CPC H04W 52/0206; H04B 7/022

(57) ABSTRACT

Techniques for generating and executing power consumption profiles for at least one node of a distributed antenna system are described. In executing each power consumption profile, the distributed antenna system can operate with reduced power consumption when advantageous while maintaining appropriate capacity and activity during periods of high activity.

### CROSS-REFERENCE TO RELATED APPLICATIONS

This application claims the benefit of U.S. Provisional Application Ser. No. 63/520,235, filed on Aug. 17, 2023, and titled “DAS POWER REDUCTION SCHEDULER”, the contents of which are incorporated herein in their entirety.

### BACKGROUND

A distributed antenna system (DAS) typically includes one or more master units that are communicatively coupled to a plurality of remotely located access points or antenna units (also referred to here as “radio units”), where each access point can be coupled directly to one or more of the mater units or indirectly via one or more other remote units and/or via one or more intermediary or expansion units or nodes. A DAS is typically used to improve the coverage provided by one or more base stations that are coupled to the central access nodes. These base stations can be coupled to the one or more master units via one or more cables or via a wireless connection, for example, using one or more donor antennas. The wireless service provided by the base stations can include commercial cellular service and/or private or public safety wireless communications. A DAS is typically utilized by multiple carriers providing wireless service, in which each carrier provides wireless signals in one or more coverage areas supported by the DAS.

### SUMMARY

The details of one or more embodiments are set forth in the description below. The features illustrated or described in connection with one exemplary embodiment may be combined with the features of other embodiments. Thus, any of the various embodiments described herein can be combined to provide further embodiments. Aspects of the embodiments can be modified, if necessary to employ concepts of the various patents, applications and publications as identified herein to provide yet further embodiments.

In one embodiment, a distributed antenna system is disclosed. The distributed antenna system comprises at least one master unit. The at least one master unit is configured to receive downlink signals from at least one base station entity. The at least one master unit is configured to generate downlink transport signals based on the downlink signals. The distributed antenna system comprises a plurality of remote units communicatively coupled to the at least one master unit. The plurality of remote units is configured to generate downlink radio frequency (RF) signals based on the downlink transport signals. The plurality of remote units is configured to radiate the downlink RF signals to user equipment in at least one coverage zone. At least one node of the distributed antenna system comprises processing circuitry configured to execute power reduction activity in the distributed antenna system. A first node of the at least one node is configured to generate at least one power consumption profile in response to receiving one or more operability parameters associated with the at least one node. Each at least one power consumption profile governs power consumption of the at least one node according to at least one time period based on the one or more operability parameters. The first node is configured to determine whether a condition of the at least one power consumption profile has been triggered. In response to determining that the condition of the at least one power consumption profile has been triggered, the first node is configured to configure the at least one node according to the one or more operability parameters of the at least one power consumption profile.

In another embodiment, a method is disclosed. The method comprises receiving one or more operability parameters associated with at least one node of a distributed antenna system. Each at least one power consumption profile governs power consumption of at least one of the at least one node according to at least one time period based on the one or more operability parameters. The method comprises generating at least one power consumption profile in response to receiving one or more operability parameters associated with the at least one node. The method comprises determining whether a condition of the at least one power consumption profile has been triggered. In response to determining that the condition of the at least one power consumption profile has been triggered, the method comprises configuring the at least one node according to the one or more operability parameters of the at least one power consumption profile.

In yet another embodiment, a distributed antenna system is disclosed. The distributed antenna system is communicatively coupled to at least one base station entity. The distributed antenna system comprises a plurality of nodes and at least one processor coupled to or integrated in at least one of the plurality of nodes. The at least one processor is configured to execute a scheduler application for executing power reduction activity in the distributed antenna system. By executing the scheduler application the at least one processor is configured to generate at least one power consumption profile in response to receiving one or more operability parameters associated with at least one node of the plurality of nodes. Each at least one power consumption profile governs power consumption of the at least one node according to at least one time period based on the one or more operability parameters. The at least one processor is configured to determine whether a condition of the at least one power consumption profile has been triggered. In response to determining that the condition of the at least one power consumption profile has been triggered, the at least one processor is configured to configure the at least one node according to the one or more operability parameters of the at least one power consumption profile.

Other embodiments are also disclosed, as subsequently described.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, as briefly summarized below and as described further in the detailed description.

FIGS. 1-4 depict block diagrams of exemplary systems configured to provide wireless service to user equipment, as described in one or more embodiments.

FIG. 5 depicts a block diagram of a distributed antenna system comprising a scheduler application to define and execute at least one power consumption profile, as described in one or more embodiments.

FIG. 6 depicts a flow diagram of a method for controlling at least one node of a distributed antenna system in accordance with at least one power consumption profile, as described in one or more embodiments.

FIG. 7 depicts a flow diagram of a method for selecting a power consumption profile between conflicting parameters of multiple power consumption profiles, as described in one or more embodiments.

FIG. 8 depicts a flow diagram of a method for executing a power consumption profile for at least one node of a distributed antenna system, as described in one or more embodiments.

FIG. 9 depicts a flow diagram of a method for scheduling a power consumption profile of a distributed antenna system, as described in one or more embodiments.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

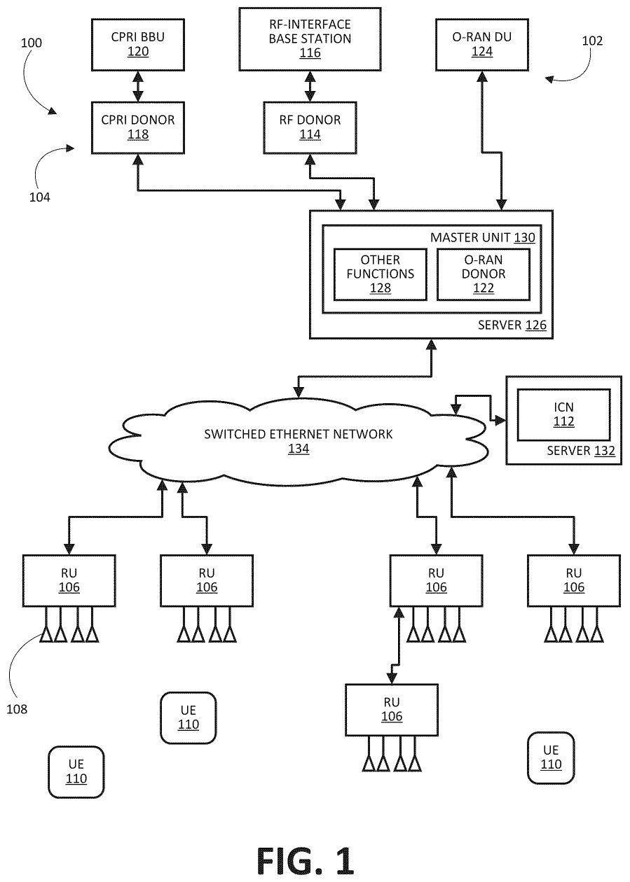

FIG. 1 is a block diagram illustrating an exemplary embodiment of a distributed antenna system (DAS) 100 that is configured to serve one or more base stations 102. In the exemplary embodiment shown in FIG. 1, the DAS 100 includes one or more donor units 104 that are used to couple the DAS 100 to the base stations 102. The DAS 100 also includes a plurality of remotely located radio units (RUs) 106 (also referred to as “antenna units,” “access points,” “remote units,” or “remote antenna units”). The RUs 106 are communicatively coupled to the donor units 104.

Each RU 106 includes, or is otherwise associated with, a respective set of coverage antennas 108 via which downlink analog RF signals can be radiated to user equipment (UEs) 110 and via which uplink analog RF signals transmitted by UEs 110 can be received. The DAS 100 is configured to serve each base station 102 using a respective subset of RUs 106 (which may include less than all of the RUs 106 of the DAS 100). Also, the subsets of RUs 106 used to serve the base stations 102 may differ from base station 102 to base station 102. The subset of RUs points 106 used to serve a given base station 102 is also referred to here as the “simulcast zone” for that base station 102. In general, the wireless coverage of a base station 102 served by the DAS 100 is improved by radiating a set of downlink RF signals for that base station 102 from the coverage antennas 108 associated with the multiple RUs 106 in that base station's stations simulcast zone and by producing a single “combined” set of uplink base station signals or data that is provided to that base station 102. The single combined set of uplink base station signals or data is produced by a combining or summing process that uses inputs derived from the uplink RF signals received via the coverage antennas 108 associated with the RUs 106 in that base station's simulcast zone.

The DAS 100 can also include one or more intermediary combining nodes (ICNs) 112 (also referred to as “expansion” units or nodes). For each base station 102 served by a given ICN 112, the ICN 112 is configured to receive a set of uplink transport data for that base station 102 from a group of “southbound” entities (that is, from RUs 106 and/or other ICNs 112) and generate a single set of combined uplink transport data for that base station 102, which the ICN 112 transmits “northbound” towards the donor unit 104 serving that base station 102. The single set of combined uplink transport data for each served base station 102 is produced by a combining or summing process that uses inputs derived from the uplink RF signals received via the coverage antennas 108 of any southbound RUs 106 included in that base station's simulcast zone. As used here, “southbound” refers to traveling in a direction “away,” or being relatively “farther,” from the donor units 104 and base stations 102, and “northbound” refers to traveling in a direction “towards”, or being relatively “closer” to, the donor units 104 and base stations 102.

In some configurations, each ICN 112 also forwards downlink transport data to the group of southbound RUs 106 and/or ICNs 112 served by that ICN 112. Generally, ICNs 112 can be used to increase the number of RUs 106 that can be served by the donor units 104 while reducing the processing and bandwidth load relative to having the additional RUs 106 communicate directly with each such donor unit 104.

Also, one or more RUs 106 can be configured in a “daisy-chain” or “ring” configuration in which transport data for at least some of those RUs 106 is communicated via at least one other RU 106. Each RU 106 would also perform the combining or summing process for any base station 102 that is served by that RU 106 and one or more of the southbound entities subtended from that RU 106. (Such a RU 106 also forwards northbound all other uplink transport data received from its southbound entities.)

The DAS 100 can include various types of donor units 104. One example of a donor unit 104 is an RF donor unit 114 that is configured to couple the DAS 100 to a base station 116 using the external analog radio frequency (RF) interface of the base station 116 that would otherwise be used to couple the base station 116 to one or more antennas (if the DAS 100 were not being used). This type of base station 116 is also referred to here as an “RF-interface” base station 116. An RF-interface base station 116 can be coupled to a corresponding RF donor unit 114 by coupling each antenna port of the base station 116 to a corresponding port of the RF donor unit 114.

Each RF donor unit 114 serves as an interface between each served RF-interface base station 116 and the rest of the DAS 100 and receives downlink base station signals from, and outputs uplink base station signals to, each served RF-interface base station 116. Each RF donor unit 114 performs at least some of the conversion processing necessary to convert the base station signals to and from the digital fronthaul interface format natively used in the DAS 100 for communicating time-domain baseband data. The downlink and uplink base station signals communicated between the RF-interface base station 116 and the donor unit 114 are analog RF signals. Also, in this example, the digital fronthaul interface format natively used in the DAS 100 for communicating time-domain baseband data can comprise the O-RAN fronthaul interface, a CPRI or enhanced CPRI (eCPRI) digital fronthaul interface format, or a proprietary digital fronthaul interface format (though other digital fronthaul interface formats can also be used).

Another example of a donor unit 104 is a digital donor unit that is configured to communicatively couple the DAS 100 to a baseband entity using a digital baseband fronthaul interface that would otherwise be used to couple the baseband entity to a radio unit (if the DAS 100 were not being used). In the example shown in FIG. 1, two types of digital donor units are shown.

The first type of digital donor unit comprises a digital donor unit 118 that is configured to communicatively couple the DAS 100 to a baseband unit (BBU) 120 using a time-domain baseband fronthaul interface implemented in accordance with a Common Public Radio Interface (“CPRI”) specification. This type of digital donor unit 118 is also referred to here as a “CPRI” donor unit 118, and this type of BBU 120 is also referred to here as a CPRI BBU 120. For each CPRI BBU 120 served by a CPRI donor unit 118, the CPRI donor unit 118 is coupled to the CPRI BBU 120 using the CPRI digital baseband fronthaul interface that would otherwise be used to couple the CPRI BBU 120 to a CPRI remote radio head (RRH) (if the DAS 100 were not being used). A CPRI BBU 120 can be coupled to a corresponding CPRI donor unit 118 via a direct CPRI connection.

Each CPRI donor unit 118 serves as an interface between each served CPRI BBU 120 and the rest of the DAS 100 and receives downlink base station signals from, and outputs uplink base station signals to, each CPRI BBU 120. Each CPRI donor unit 118 performs at least some of the conversion processing necessary to convert the CPRI base station data to and from the digital fronthaul interface format natively used in the DAS 100 for communicating time-domain baseband data. The downlink and uplink base station signals communicated between each CPRI BBU 120 and the CPRI donor unit 118 comprise downlink and uplink fronthaul data generated and formatted in accordance with the CPRI baseband fronthaul interface.

The second type of digital donor unit comprises a digital donor unit 122 that is configured to communicatively couple the DAS 100 to a BBU 124 using a frequency-domain baseband fronthaul interface implemented in accordance with a O-RAN Alliance specification. The acronym “O-RAN” is an abbreviation for “Open Radio Access Network.” This type of digital donor unit 122 is also referred to here as an “O-RAN” donor unit 122, and this type of BBU 124 is typically an O-RAN distributed unit (DU) and is also referred to here as an O-RAN DU 124. For each O-RAN DU 124 served by a O-RAN donor unit 122, the O-RAN donor unit 122 is coupled to the O-DU 124 using the O-RAN digital baseband fronthaul interface that would otherwise be used to couple the O-RAN DU 124 to a O-RAN RU (if the DAS 100 were not being used). An O-RAN DU 124 can be coupled to a corresponding O-RAN donor unit 122 via a switched Ethernet network. Alternatively, an O-RAN DU 124 can be coupled to a corresponding O-RAN donor unit 122 via a direct Ethernet or CPRI connection.

Each O-RAN donor unit 122 serves as an interface between each served O-RAN DU 124 and the rest of the DAS 100 and receives downlink base station signals from, and outputs uplink base station signals to, each O-RAN DU 124. Each O-RAN donor unit 122 performs at least some of any conversion processing necessary to convert the base station signals to and from the digital fronthaul interface format natively used in the DAS 100 for communicating frequency-domain baseband data. The downlink and uplink base station signals communicated between each O-RAN DU 124 and the O-RAN donor unit 122 comprise downlink and uplink fronthaul data generated and formatted in accordance with the O-RAN baseband fronthaul interface, where the user-plane data comprises frequency-domain baseband IQ data. Also, in this example, the digital fronthaul interface format natively used in the DAS 100 for communicating O-RAN fronthaul data is the same O-RAN fronthaul interface used for communicating base station signals between each O-RAN DU 124 and the O-RAN donor unit 122, and the “conversion” performed by each O-RAN donor unit 122 (and/or one or more other entities of the DAS 100) includes performing any needed “multicasting” of the downlink data received from each O-RAN DU 124 to the multiple RUs 106 in a simulcast zone for that O-RAN DU 124 (for example, by communicating the downlink fronthaul data to an appropriate multicast address and/or by copying the downlink fronthaul data for communication over different fronthaul links) and performing any need combining or summing of the uplink data received from the RUs 106 to produce combined uplink data provided to the O-RAN DU 124. It is to be understood that other digital fronthaul interface formats can also be used.

In general, the various base stations 102 are configured to communicate with a core network (not shown) of the associated wireless operator using an appropriate backhaul network (typically, a public wide area network such as the Internet). Also, the various base stations 102 may be from multiple, different wireless operators and/or the various base stations 102 may support multiple, different wireless protocols and/or RF bands.

In general, for each base station 102, the DAS 100 is configured to receive a set of one or more downlink base station signals from the base station 102 (via an appropriate donor unit 104), generate downlink transport data derived from the set of downlink base station signals, and transmit the downlink transport data to the RUs 106 in the base station's simulcast zone. For each base station 102 served by a given RU 106, the RU 106 is configured to receive the downlink transport data transmitted to it via the DAS 100 and use the received downlink transport data to generate one or more downlink analog radio frequency signals that are radiated from one or more coverage antennas 108 associated with that RU 106 for reception by user equipment 110. In this way, the DAS 100 increases the coverage area for the downlink capacity provided by the base stations 102. Also, for any southbound entities (for example, southbound RUs 106 or ICNs 112) coupled to the RU 106 (for example, in a daisy chain or ring architecture), the RU 106 forwards any downlink transport data intended for those southbound entities towards them.

For each base station 102 served by a given RU 106, the RU 106 is configured to receive one or more uplink radio frequency signals transmitted from the user equipment 110. These signals are analog radio frequency signals and are received via the coverage antennas 108 associated with that RU 106. The RU 106 is configured to generate uplink transport data derived from the one or more remote uplink radio frequency signals received for the served base station 102 and transmit the uplink transport data northbound towards the donor unit 104 coupled to that base station 102.

For each base station 102 served by the DAS 100, a single “combined” set of uplink base station signals or data is produced by a combining or summing process that uses inputs derived from the uplink RF signals received via the RUs 106 in that base station's simulcast zone. The resulting final single combined set of uplink base station signals or data is provided to the base station 102. This combining or summing process can be performed in a centralized manner in which the combining or summing process is performed by a single unit of the DAS 100 (for example, a donor unit 104 or master unit 130). This combining or summing process can also be performed in a distributed or hierarchical manner in which the combining or summing process is performed by multiple units of the DAS 100 (for example, a donor unit 104 (or master unit 130) and one or more ICNs 112 and/or RUs 106). Each unit of the DAS 100 that performs the combining or summing process for a given base station 102 receives uplink transport data from that unit's southbound entities and uses that data to generate combined uplink transport data, which the unit transmits northbound towards the base station 102. The generation of the combined uplink transport data involves, among other things, extracting in-phase and quadrature (IQ) data from the received uplink transport data and performing a combining or summing process using any uplink IQ data for that base station 102 in order to produce combined uplink IQ data.

Some of the details regarding how base station signals or data are communicated and transport data is produced vary based on which type of base station 102 is being served. In the case of an RF-interface base station 116, the associated RF donor unit 114 receives analog downlink RF signals from the RF-interface base station 116 and, either alone or in combination with one or more other units of the DAS 100, converts the received analog downlink RF signals to the digital fronthaul interface format natively used in the DAS 100 for communicating time-domain baseband data (for example, by digitizing, digitally down-converting, and filtering the received analog downlink RF signals in order to produce digital baseband IQ data and formatting the resulting digital baseband IQ data into packets) and communicates the resulting packets of downlink transport data to the various RUs 106 in the simulcast zone of that base station 116. The RUs 106 in the simulcast zone for that base station 116 receive the downlink transport data and use it to generate and radiate downlink RF signals as described above. In the uplink, either alone or in combination with one or more other units of the DAS 100, the RF donor unit 114 generates a set of uplink base station signals from uplink transport data received by the RF donor unit 114 (and/or the other units of the DAS 100 involved in this process). The set of uplink base station signals is provided to the served base station 116. The uplink transport data is derived from the uplink RF signals received at the RUs 106 in the simulcast zone of the served base station 116 and communicated in packets.

In the case of a CPRI BBU 120, the associated CPRI digital donor unit 118 receives CPRI downlink fronthaul data from the CPRI BBU 120 and, either alone or in combination with another unit of the DAS 100, converts the received CPRI downlink fronthaul data to the digital fronthaul interface format natively used in the DAS 100 for communicating time-domain baseband data (for example, by re-sampling, synchronizing, combining, separating, gain adjusting, etc. the CPRI baseband IQ data, and formatting the resulting baseband IQ data into packets), and communicates the resulting packets of downlink transport data to the various RUs 106 in the simulcast zone of that CPRI BBU 120. The RUs 106 in the simulcast zone of that CPRI BBU 120 receive the packets of downlink transport data and use them to generate and radiate downlink RF signals as described above. In the uplink, either alone or in combination with one or more other units of the DAS 100, the CPRI donor unit 118 generates uplink base station data from uplink transport data received by the CPRI donor unit 118 (and/or the other units of the DAS 100 involved in this process). The resulting uplink base station data is provided to that CPRI BBU 120. The uplink transport data is derived from the uplink RF signals received at the RUs 106 in the simulcast zone of the CPRI BBU 120.

In the case of an O-RAN DU 124, the associated O-RAN donor unit 122 receives packets of O-RAN downlink fronthaul data (that is, O-RAN user-plane and control-plane messages) from each O-RAN DU 124 coupled to that O-RAN digital donor unit 122 and, cither alone or in combination with another unit of the DAS 100, converts (if necessary) the received packets of O-RAN downlink fronthaul data to the digital fronthaul interface format natively used in the DAS 100 for communicating O-RAN baseband data and communicates the resulting packets of downlink transport data to the various RUs 106 in a simulcast zone for that ORAN DU 124. The RUs 106 in the simulcast zone of each O-RAN DU 124 receive the packets of downlink transport data and use them to generate and radiate downlink RF signals as described above. In the uplink, either alone or in combination with one or more other units of the DAS 100, the O-RAN donor unit 122 generates packets of uplink base station data from uplink transport data received by the O-RAN donor unit 122 (and/or the other units of the DAS 100 involved in this process). The resulting packets of uplink base station data are provided to the O-RAN DU 124. The uplink transport data is derived from the uplink RF signals received at the RUs 106 in the simulcast zone of the served O-RAN DU 124 and communicated in packets.

In one implementation, one of the units of the DAS 100 is also used to implement a “master” timing entity for the DAS 100 (for example, such a master timing entity can be implemented as a part of a master unit 130 described below). In another example, a separate, dedicated timing master entity (not shown) is provided within the DAS 100. In either case, the master timing entity synchronizes itself to an external timing master entity (for example, a timing master associated with one or more of the O-DUs 124) and, in turn, that entity serves as a timing master entity for the other units of the DAS 100. A time synchronization protocol (for example, the Institute of Electrical and Electronics Engineers (IEEE) 1588 Precision Time Protocol (PTP), the Network Time Protocol (NTP), or the Synchronous Ethernet (SyncE) protocol) can be used to implement such time synchronization.

A management system can be used to manage the various nodes of the DAS 100. In one implementation, the management system communicates with a predetermined “master” entity for the DAS 100 (for example, the master unit 130 described below), which in turns forwards or otherwise communicates with the other units of the DAS 100 for management-plane purposes. In another implementation, the management system communicates with the various units of the DAS 100 directly for management-plane purposes (that is, without using a master entity as a gateway).

Each base station 102 (including each RF-interface base station 116, CPRI BBU 120, and O-RAN DU 124), donor unit 104 (including each RF donor unit 114, CPRI donor unit 118, and O-RAN donor unit 122), RU 106, ICN 112, and any of the specific features described here as being implemented thereby, can be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory storage medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented the software. Such hardware or software (or portions thereof) can be implemented in other ways (for example, in an application specific integrated circuit (ASIC), etc.). Such entities can be implemented in other ways.

The DAS 100 can be implemented in a virtualized manner or a non-virtualized manner. When implemented in a virtualized manner, one or more nodes, units, or functions of the DAS 100 are implemented using one or more virtual network functions (VNFs) executing on one or more physical server computers (also referred to here as “physical servers” or just “servers”) (for example, one or more commercial-off-the-shelf (COTS) servers of the type that are deployed in data centers or “clouds” maintained by enterprises, communication service providers, or cloud services providers). More specifically, in the exemplary embodiment shown in FIG. 1, each O-RAN donor unit 122 is implemented as a VNF running on a server 126. The server 126 can execute other VNFs 128 that implement other functions for the DAS 100 (for example, fronthaul, management plane, and synchronization plane functions). The various VNFs executing on the server 126 are also referred to here as “master unit” functions 130 or, collectively, as the “master unit” 130. Also, in the exemplary embodiment shown in FIG. 1, each ICN 112 is implemented as a VNF running on a server 132.

The RF donor units 114 and CPRI donor units 118 can be implemented as cards (for example, Peripheral Component Interconnect (PCI) Cards) that are inserted in the server 126. Alternatively, the RF donor units 114 and CPRI donor units 118 can be implemented as separate devices that are coupled to the server 126 via dedicated Ethernet links or via a switched Ethernet network (for example, the switched Ethernet network 134 described below).

In the exemplary embodiment shown in FIG. 1, the donor units 104, RUs 106 and ICNs 112 are communicatively coupled to one another via a switched Ethernet network 134. Also, in the exemplary embodiment shown in FIG. 1, an O-RAN DU 124 can be coupled to a corresponding O-RAN donor unit 122 via the same switched Ethernet network 134 used for communication within the DAS 100 (though each O-RAN DU 124 can be coupled to a corresponding O-RAN donor unit 122 in other ways). In the exemplary embodiment shown in FIG. 1, the downlink and uplink transport data communicated between the units of the DAS 100 is formatted as O-RAN data that is communicated in Ethernet packets over the switched Ethernet network 134. In the exemplary embodiment shown in FIG. 1, the RF donor units 114 and CPRI donor units 118 are coupled to the RUs 106 and ICNs 112 via the master unit 130.

In the downlink, the RF donor units 114 and CPRI donor units 118 provide downlink time-domain baseband IQ data to the master unit 130. The master unit 130 generates downlink O-RAN user-plane messages containing downlink baseband IQ that is either the time-domain baseband IQ data provided from the donor units 114 and 118 or is derived therefrom (for example, where the master unit 130 converts the received time-domain baseband IQ data into frequency-domain baseband IQ data). The master unit 130 also generates corresponding downlink O-RAN control-plane messages for those O-RAN user-plane messages. The resulting downlink O-RAN user-plane and control-plane messages are communicated (multicasted) to the RUs 106 in the simulcast zone of the corresponding base station 102 via the switched Ethernet network 134.

In the uplink, for each RF-interface base station 116 and CPRI BBU 120, the master unit 130 receives O-RAN uplink user-plane messages for the base station 116 or CPRI BBU 120 and performs a combining or summing process using the uplink baseband IQ data contained in those messages in order to produce combined uplink baseband IQ data, which is provided to the appropriate RF donor unit 114 or CPRI donor unit 118. The RF donor unit 114 or CPRI donor unit 118 uses the combined uplink baseband IQ data to generate a set of base station signals or CPRI data that is communicated to the corresponding RF-interface base station 116 or CPRI BBU 120. If time-domain baseband IQ data has been converted into frequency-domain baseband IQ data for transport over the DAS 100, the donor unit 114 or 118 also converts the combined uplink frequency-domain IQ data into combined uplink time-domain IQ data as part of generating the set of base station signals or CPRI data that is communicated to the corresponding RF-interface base station 116 or CPRI BBU 120.

In the exemplary embodiment shown in FIG. 1, the master unit 130 (more specifically, the O-RAN donor unit 122) receives downlink O-RAN user-plane and control-plane messages from each served O-RAN DU 124 and communicates (multicasts) them to the RUs 106 in the simulcast zone of the corresponding O-RAN DU 124 via the switched Ethernet network 134. In the uplink, the master unit 130 (more specifically, the O-RAN donor unit 122) receives O-RAN uplink user-plane messages for each served O-RAN DU 124 and performs a combining or summing process using the uplink baseband IQ data contained in those messages in order to produce combined uplink IQ data. The O-RAN donor unit 122 produces O-RAN uplink user-plane messages containing the combined uplink baseband IQ data and communicates those messages to the O-RAN DU 124.

In the exemplary embodiment shown in FIG. 1, only uplink transport data is communicated using the ICNs 112, and downlink transport data is communicated from the master unit 130 to the RUs 106 without being forwarded by, or otherwise communicated using, the ICNs 112.

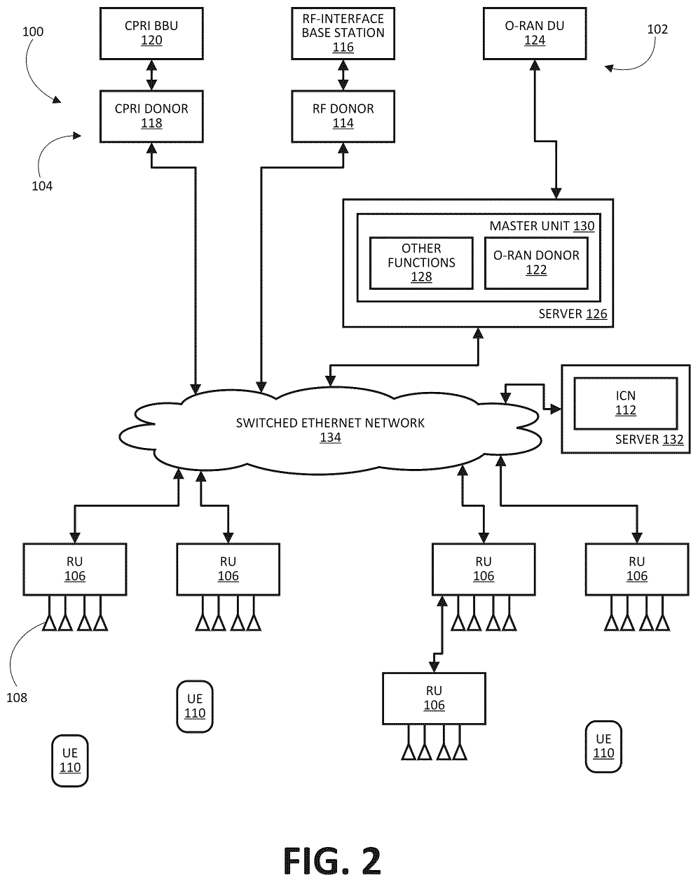

FIG. 2 illustrates another exemplary embodiment of a DAS 100. The DAS 100 shown in FIG. 2 is the same as the DAS 100 shown in FIG. 1 except as described below. In the exemplary embodiment shown in FIG. 2, the RF donor units 114 and CPRI donor units 118 are coupled directly to the switched Ethernet network 134 and not via the master unit 130, as is the case in the embodiment shown in FIG. 1.

As described above, in the exemplary embodiment shown in FIG. 1, the master unit 130 performs some transport functions related to serving the RF-interface base stations 116 and CPRI BBUs 120 coupled to the donor units 114 and 118. In the exemplary embodiment shown in FIG. 2, the RF donor units 114 and CPRI donor units 118 perform those transport functions (that is, the RF donor units 114 and CPRI donor units 118 perform all of the transport functions related to serving the RF-interface base stations 116 and CPRI BBUs 120, respectively).

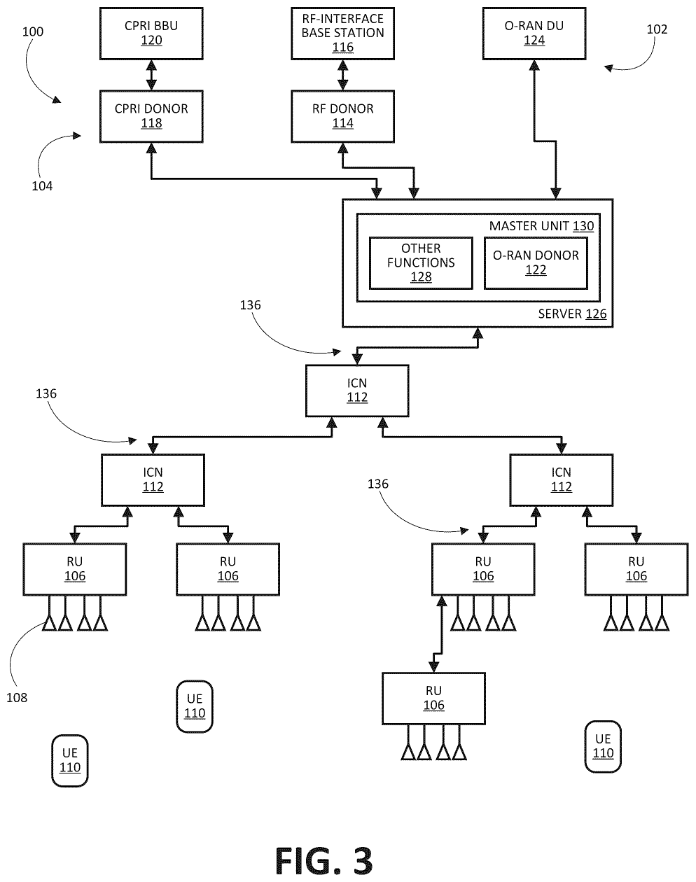

FIG. 3 illustrates another exemplary embodiment of a DAS 100. The DAS 100 shown in FIG. 3 is the same as the DAS 100 shown in FIG. 1 except as described below. In the exemplary embodiment shown in FIG. 3, the donor units 104, RUs 106 and ICNs 112 are communicatively coupled to one another via point-to-point Ethernet links 136 (instead of a switched Ethernet network). Also, in the exemplary embodiment shown in FIG. 3, an O-RAN DU 124 can be coupled to a corresponding O-RAN donor unit 122 via a switched Ethernet network (not shown in FIG. 3), though that switched Ethernet network is not used for communication within the DAS 100. In the exemplary embodiment shown in FIG. 3, the downlink and uplink transport data communicated between the units of the DAS 100 is communicated in Ethernet packets over the point-to-point Ethernet links 136.

For each southbound point-to-point Ethernet link 136 that couples a master unit 130 to an ICN 112, the master unit 130 assembles downlink transport frames and communicates them in downlink Ethernet packets to the ICN 112 over the point-to-point Ethernet link 136. For each point-to-point Ethernet link 136, each downlink transport frame multiplexes together downlink time-domain baseband IQ data and Ethernet data that needs to be communicated to southbound RUs 106 and ICNs 112 that are coupled to the master unit 130 via that point-to-point Ethernet link 136. The downlink time-domain baseband IQ data is sourced from one or more RF donor units 114 and/or CPRI donor units 118. The Ethernet data comprises downlink user-plane and control-plane O-RAN fronthaul data sourced from one or more O-RAN donor units 122 and/or management-plane data sourced from one or more management entities for the DAS 100. That is, this Ethernet data is encapsulated into downlink transport frames that are also used to communicate downlink time-domain baseband IQ data and this Ethernet data is also referred to here as “encapsulated” Ethernet data. The resulting downlink transport frames are communicated in the payload of downlink Ethernet packets communicated from the master unit 130 to the ICN 112 over the point-to-point Ethernet link 136. The Ethernet packets into which the encapsulated Ethernet data is encapsulated are also referred to here as “transport” Ethernet packets.

Each ICN 112 receives downlink transport Ethernet packets via each northbound point-to-point Ethernet link 136 and extracts any downlink time-domain baseband IQ data and/or encapsulated Ethernet data included in the downlink transport frames communicated via the received downlink transport Ethernet packets. Any encapsulated Ethernet data that is intended for the ICN 112 (for example, management-plane Ethernet data) is processed by the ICN 112.

For each southbound point-to-point Ethernet link 136 coupled to the ICN 112, the ICN 112 assembles downlink transport frames and communicates them in downlink Ethernet packets to the southbound entities subtended from the ICN 112 via the point-to-point Ethernet link 136. For each southbound point-to-point Ethernet link 136, each downlink transport frame multiplexes together downlink time-domain baseband IQ data and Ethernet data received at the ICN 112 that needs to be communicated to those subtended southbound entities. The resulting downlink transport frames are communicated in the payload of downlink transport Ethernet packets communicated from the ICN 112 to those subtended southbound entities ICN 112 over the point-to-point Ethernet link 136.

Each RU 106 receives downlink transport Ethernet packets via each northbound point-to-point Ethernet link 136 and extracts any downlink time-domain baseband IQ data and/or encapsulated Ethernet data included in the downlink transport frames communicated via the received downlink transport Ethernet packets. As described above, the RU 106 uses any downlink time-domain baseband IQ data and/or downlink O-RAN user-plane and control-plane fronthaul messages to generate downlink RF signals for radiation from the set of coverage antennas 108 associated with that RU 106. The RU 106 processes any management-plane messages communicated to that RU 106 via encapsulated Ethernet data.

Also, for any southbound point-to-point Ethernet link 136 coupled to the RU 106, the RU 106 assembles downlink transport frames and communicates them in downlink Ethernet packets to the southbound entities subtended from the RU 106 via the point-to-point Ethernet link 136. For each southbound point-to-point Ethernet link 136, each downlink transport frame multiplexes together downlink time-domain baseband IQ data and Ethernet data received at the RU 106 that needs to be communicated to those subtended southbound entities. The resulting downlink transport frames are communicated in the payload of downlink transport Ethernet packets communicated from the RU 106 to those subtended southbound entities ICN 112 over the point-to-point Ethernet link 136.

In the uplink, each RU 106 generates uplink time-domain baseband IQ data and/or uplink O-RAN user-plane fronthaul messages for each RF-interface base station 116, CPRI BBU 120, and/or O-RAN DU 124 served by that RU 106 as described above. For each northbound point-to-point Ethernet link 136 of the RU 106, the RU 106 assembles uplink transport frames and communicates them in uplink transport Ethernet packets northbound towards the appropriate master unit 130 via that point-to-point Ethernet link 136. For each northbound point-to-point Ethernet link 136, each uplink transport frame multiplexes together uplink time-domain baseband IQ data originating from that RU 106 and/or any southbound entity subtended from that RU 106 as well as any Ethernet data originating from that RU 106 and/or any southbound entity subtended from that RU 106. In connection with doing this, the RU 106 performs the combining or summing process described above for any base station 102 served by that RU 106 and also by one or more of the subtended entities. (The RU 106 forwards northbound all other uplink data received from those southbound entities.) The resulting uplink transport frames are communicated in the payload of uplink transport Ethernet packets northbound towards the master unit 130 via the associated point-to-point Ethernet link 136.

Each ICN 112 receives uplink transport Ethernet packets via each southbound point-to-point Ethernet link 136 and extracts any uplink time-domain baseband IQ data and/or encapsulated Ethernet data included in the uplink transport frames communicated via the received uplink transport Ethernet packets. For each northbound point-to-point Ethernet link 136 coupled to the ICN 112, the ICN 112 assembles uplink transport frames and communicates them in uplink transport Ethernet packets northbound towards the master unit 130 via that point-to-point Ethernet link 136. For each northbound point-to-point Ethernet link 136, each uplink transport frame multiplexes together uplink time-domain baseband IQ data and Ethernet data received at the ICN 112 that needs to be communicated northbound towards the master unit 130. The resulting uplink transport frames are communicated in the payload of uplink transport Ethernet packets communicated northbound towards the master unit 130 over the point-to-point Ethernet link 136.

Each master unit 130 receives uplink transport Ethernet packets via each southbound point-to-point Ethernet link 136 and extracts any uplink time-domain baseband IQ data and/or encapsulated Ethernet data included in the uplink transport frames communicated via the received uplink transport Ethernet packets. Any extracted uplink time-domain baseband IQ data, as well as any uplink O-RAN messages communicated in encapsulated Ethernet, is used in producing a single “combined” set of uplink base station signals or data for the associated base station 102 as described above (which includes performing the combining or summing process). Any other encapsulated Ethernet data (for example, management-plane Ethernet data) is forwarded on towards the respective destination (for example, a management entity).

In the exemplary embodiment shown in FIG. 3, synchronization-plane messages are communicated using native Ethernet packets (that is, non-encapsulated Ethernet packets) that are interleaved between the transport Ethernet packets.

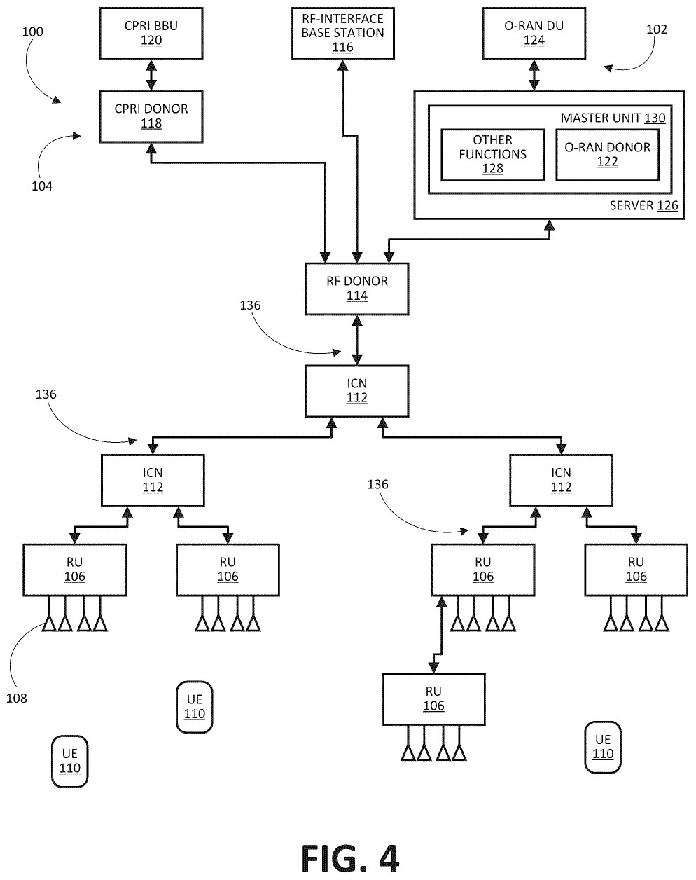

FIG. 4 illustrates another exemplary embodiment of a DAS 100. The DAS 100 shown in FIG. 4 is the same as the DAS 100 shown in FIG. 3 except as described below. In the exemplary embodiment shown in FIG. 4, the CPRI donor units 118, O-RAN donor unit 122, and master unit 130 are coupled to the RUs 106 and ICNs 112 via one or more RF units 114. That is, each RF unit 114 performs the transport frame multiplexing and demultiplexing that is described above in connection with FIG. 3 as being performed by the master unit 130.

In the distributed antenna systems 100 of FIGS. 1-4, the nodes of the DAS are generally configured for maximum traffic load. Doing so enables the DAS 100 to optimize coverage even during periods of high activity. For example, a DAS implemented in a stadium to extend wireless coverage for multiple carriers likely experiences high traffic throughput when an event is hosted at the stadium and the coverage zones provided for by the DAS 100 become saturated with user equipment 110. When the DAS 100 is configured for maximum traffic throughput, the power consumption of the DAS 100 increases and hence, the costs of operating and maintaining the DAS 100 increases, due to the increased power demands of each node to provide the necessary functionality.

However, maximum traffic is not always present, and during periods of lower traffic throughput the DAS 100 does not need to maximize capacity. Assessing when it is appropriate to limit DAS functionality is important, as powering down the DAS 100 during periods of high traffic throughput will likely result in sub-optimal coverage or even loss of coverage.

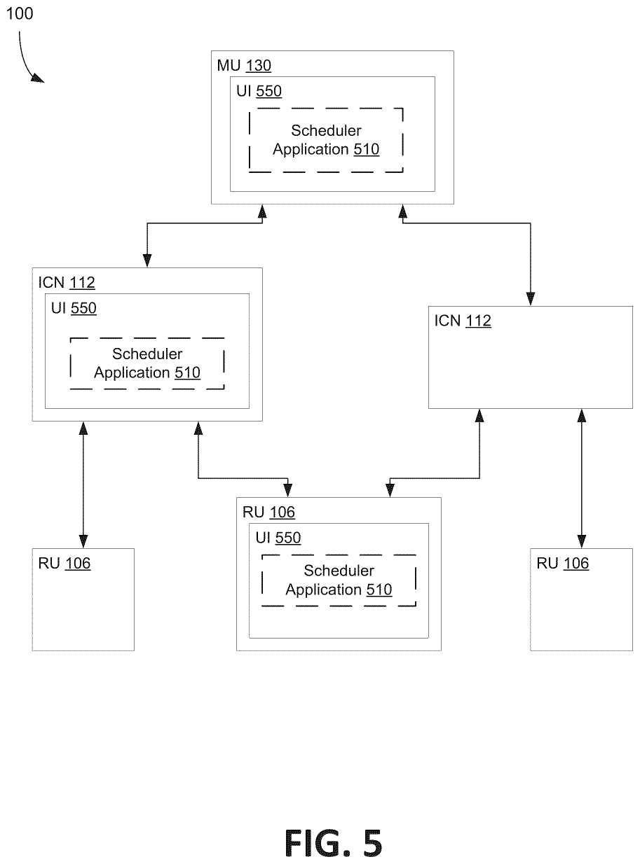

To provide dynamic and selective power reduction mechanisms, one or more power consumption profiles can be defined in the DAS 100, which, when implemented, reduce power consumption in the DAS 100 for selected nodes. Doing so enables power the DAS 100 to reduce power consumption during periods in which it would be advantageous for the DAS 100 to utilize less power, while maintaining necessary functionality when needed to extend coverage of one or more base station entities. Referring to FIG. 5, one or more of the nodes of DAS 100 include a scheduler application 510 that is configured to define and execute one or more power consumption profiles. Each power consumption profile governs operational activity of all active nodes in the DAS 100, as further described herein.

The scheduler application 510 can be implemented through appropriate processing circuitry for each node that is used to implement the scheduling functionality. In the example shown in FIG. 5, scheduler application 510 can be executed by at least one processor included in master unit (MU) 130, ICN 112, and/or RU 106, or a combination thereof. Although scheduler application 510 is shown as associated with the MU 130, ICN 112, and/or RU 106, the scheduler application 510 can also be implemented by other nodes of the DAS in addition or alternative to these nodes, including but not limited to, repeaters, relays, remote radio heads, and other RF communication devices in the DAS 100. Additionally or alternatively, the scheduler application 510 can be implemented in a system controller (not shown in FIG. 5) or other management entity that generally controls the functions of DAS 100 and the individual nodes.

In some embodiments, the scheduler application 510 is implemented in conjunction with a user (such as a technician or system operator) through an appropriate interface with a node. For example, each node that comprises scheduler application 510 includes a user interface (UI) 550 configured for receiving user input. For some advanced DAS 100 such as the virtual DAS described in conjunction with FIGS. 1-4, the UI 550 is configured to establish a wireless communication link with an electronic device such as a laptop or mobile phone. In these embodiments, the user can define, modify, and execute power consumption profiles on the electronic device remotely. For example, if a user desires to execute a new power consumption profile in which to disable one of the RUs 106 for a certain time period, the user can remotely interface with scheduler application 510 on the electronic device and input parameters that set the MU 130 in an inactive state (e.g., by setting the operational power of the MU 130 to zero) for a defined duration. In some embodiments, the UI 550 is a graphical user interface (GUI) that enables a technician to define a power consumption profile for the node directly.

After a power consumption profile has been defined, scheduler application 510 configures each node based on the parameters defined in the power consumption profile. For example, the processor(s) of the node executing the instructions of the scheduler application 510 sends control signals to the other component(s) in the node that controls the operation of the components. If a given power consumption profile specifies that the downlink (or uplink) circuitry, or one or more components thereof (e.g., D/A-A/D conversion circuitry, signal transport circuitry, amplification circuitry, etc.) be turned off, the processors of the given node send control signals to the identified circuit(s)/component(s) that cause the identified circuit(s)/component(s) to turn off (e.g., by turning off power that is supplied to the components). In some embodiments, the processors of one node can send control signals to other nodes in the DAS 100 that configure those nodes in accordance with the parameters defined in the power consumption profile. Additionally, a first node (e.g., MU 130) can control a second node (e.g., RU 106) in accordance with the power consumption profile defined for the second node. For example, if an RU 106 needs to be set to a low-power state as specified by the parameters of the power consumption profile, MU 130 manages the power consumption profile associated with RU 106 and sets RU 106 to a low-power state when necessary. In doing so, the second node does not need to be aware that it is covered under a power consumption profile.

In some embodiments, the processor(s) implementing scheduler application 510 is configured to manage alerts that would normally be issued by a node during a fault or malfunction. For example, some nodes of the DAS 100, including the MU 130, ICNs 112, and RUs 106, are configured to issue an alert to a management entity or system administrator when the node experiences a loss of operating power. When the processor(s) disables a node pursuant to the parameters of a power consumption profile, the processors(s) can monitor for an alert generated by the disabled node. If the disabled node generates an alert, the processor(s) determines whether the disabled node is one of the nodes governed by the parameters of the power consumption profile; and if so, the processor(s) then determines whether the operating power level of the disabled node is consistent with the parameters of the power consumption profile (e.g., that the power level is at or below a power threshold). If these conditions are met, then this indicates that the alarm generated by the disabled node is made in response to executing the parameters of the power consumption profile and not due to some fault or malfunction of the node. Accordingly, the processor(s) can disable the alarm generated by the disabled node.

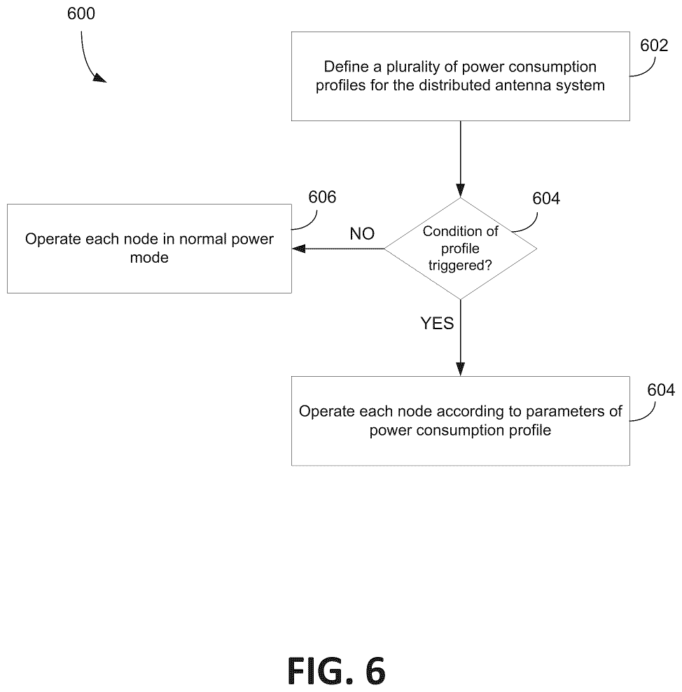

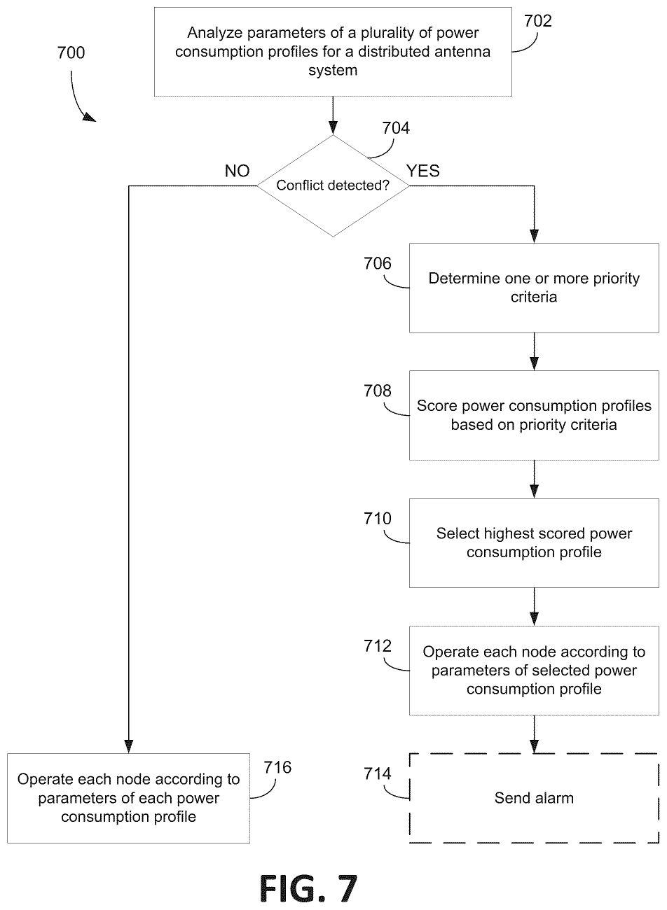

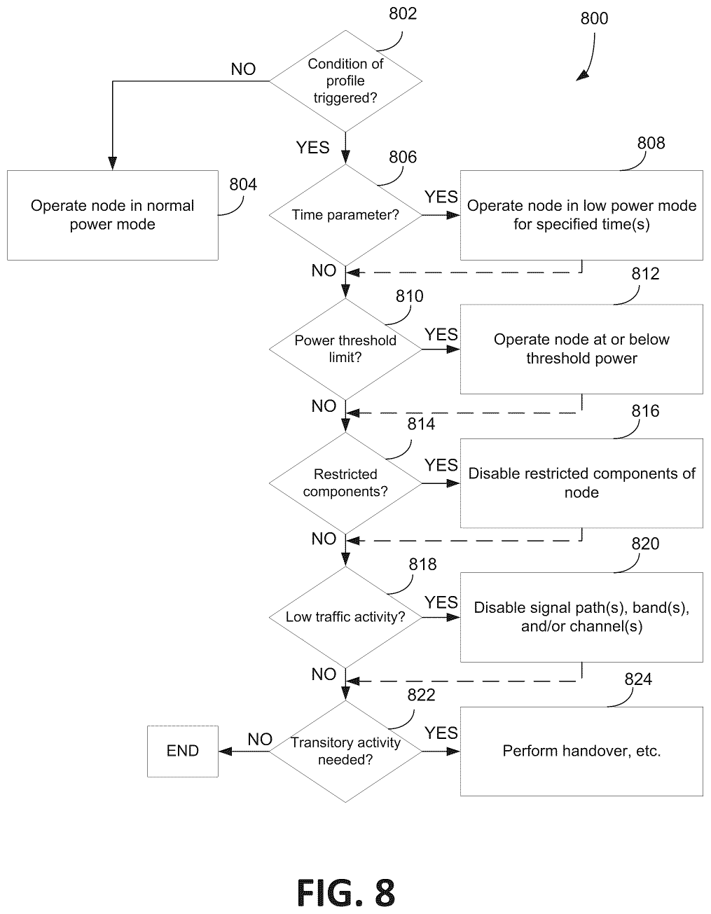

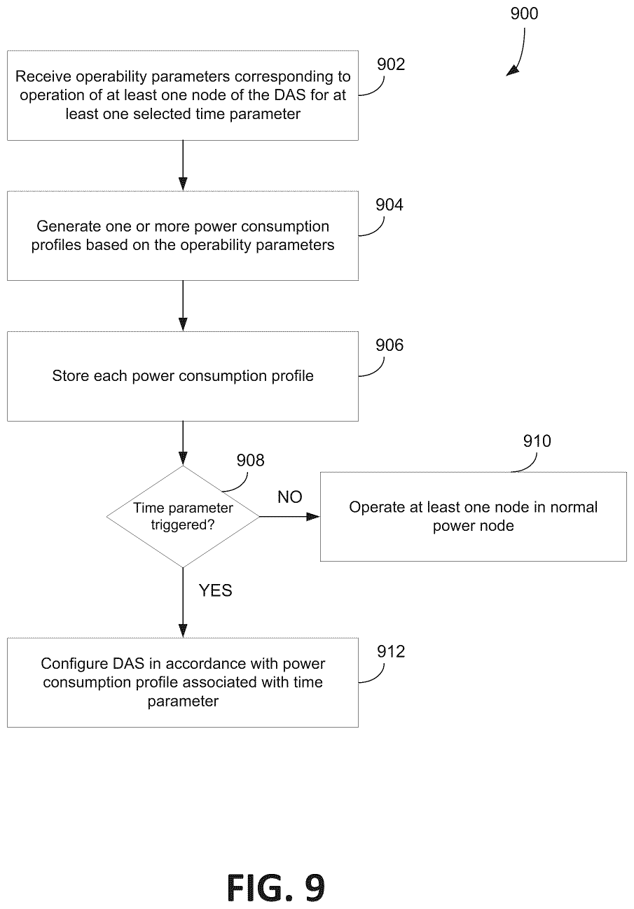

FIGS. 6-9 describe various embodiments of configuring and executing one or more power consumption profiles for at least one node of the DAS. FIG. 6 depicts a flow diagram of a method for controlling at least one node of a distributed antenna system in accordance with at least one power consumption profile. FIG. 7 depicts a flow diagram of a method for selecting a power consumption profile between conflicting parameters of multiple power consumption profiles. FIG. 8 depicts a flow diagram of a method for executing a power consumption profile for at least one node of a distributed antenna system. FIG. 9 depicts a flow diagram of a method for scheduling a power consumption profile of a distributed antenna system.

The methods generally described in FIGS. 6-9 may be implemented via the DAS embodiments described with respect to FIGS. 1-5, but may be implemented via other DAS as well. The blocks of the flow diagrams have been arranged in a generally sequential manner for ease of explanation; however, it is to be understood that this arrangement is merely exemplary, and it should be recognized that the processing associated with the methods described herein (and the blocks shown in the Figures) may occur in a different order (for example, where at least some of the processing associated with the blocks is performed in parallel and/or in an event-driven manner).

Referring to FIG. 6, method 600 includes defining a plurality of power consumption profiles for the distributed antenna system at block 602. Each power consumption profile includes a set of parameters governing power consumption for one or more nodes of the DAS. For example, a power consumption profile can define power consumption for one or more master units, one or more remote units, one or more intermediate nodes, one or more repeaters, and/or other types of nodes in the DAS described in FIGS. 1-5. A power consumption profile can also be defined for a specified duration, such as a time period in which there is low expected traffic in the DAS. In some embodiments, a profile can be defined for a recurrent time period, for example, every night or for a specified duration once every week. In some embodiments, a user or technician inputs the parameters of a power consumption profile by interfacing with one of the nodes via a user interface as described in FIG. 5, for example, by a GUI or remotely through a portable electronic device configured for communicating with the nodes of the DAS. Also, a user or technician can modify or remove an already defined power consumption profile. If expected or anticipated operating conditions indicate that one or more parameters of a power consumption profile should be changed (e.g., that an event will be hosted at a time typically when low traffic is experienced by the DAS), the user or technician, via the scheduler application 510, can set one or more nodes to be active during the time period of the event. In another example, if a remote unit has been added to a DAS that has previously deployed, a power consumption profile can be defined or modified to change the power consumption of the newly added remote unit in accordance with the needs of the DAS.

In some embodiments, multiple power consumption profiles can be generated for selected groups of nodes in the DAS. For example, if a DAS includes 40 remote units, one power consumption profile can be defined for 20 remote units, a second power consumption profile can be defined for an additional 10 remote units, and a third power consumption profile can be defined for the remaining 10 remote units (understanding that multiple power consumption profiles can be shared between nodes of different groups). A power consumption profile can be applied for a selection of a subset of nodes based on shared characteristics of the subset, for example, the type of node in the DAS, the shared physical or network location in which the group of nodes is deployed, the shared functionality of selected nodes (e.g., each node in the group is configured for downlink D/A conversion), and other shared characteristics. In one example, a power consumption profile can be defined for a remote unit or groups of remote units for specified operating power utilizations, such as one power consumption profile for 25% operating power utilization (Profile A), another power consumption profile for 50% operating power utilization (Profile B), a third power consumption profile for 75% operating power utilization (Profile C), and a fourth power consumption profile for 100% operating power utilization (Profile D). In this example, scheduler application 510 enables the controlling node (e.g., MU 130) to configure the remote units or group of remote units to operate under Profile A for a first time period (e.g., from midnight to 5:00 AM), Profile B for a second time period (e.g., from 5:00 AM to 11:00 AM), and so on for each distinct power consumption profile, depending on the expected traffic activity in the DAS.

Referring back to FIG. 6, method 600 proceeds to block 604 and determines whether condition(s) of one or more power consumption profiles have been triggered. In some embodiments, and as described further in the context of FIG. 9, the condition includes a time parameter associated with the power consumption profile. Other conditions can be used to determine whether a power consumption profile should be executed. For example, in some embodiments (see FIG. 7), the condition can include a conflict between two conflicting power consumption profiles. Additionally, or alternatively, the condition can include a capacity level of the DAS, which can be determined from the current traffic loads experienced by the DAS.

If, at block 604, method 600 determines that no condition of a power consumption profile has been triggered, method 600 proceeds to block 606 and operates each node of the DAS in a normal power mode, e.g., a mode in which the node does not have any restrictions on power consumption during operation. Alternatively, if a power consumption profile has already been activated and no condition for a different power consumption profile has been triggered, then method 600 continues to operate each node according to the parameters governed by the currently active power consumption profile. However, if method 600 determines at block 604 that a condition of a power consumption profile has been triggered (e.g., that the current time is associated with a time interval of a power consumption profile), then method 600 configures each node associated with the power consumption profile based on the parameters defined by the power consumption profile. As previously noted, a power consumption profile can define power consumption for a single node, multiple nodes (e.g., a subset of nodes), or the DAS as a whole. In some embodiments, configuring the node(s) comprises executing power reduction activity for the node(s) defined by the power consumption profile, as would be the case where the DAS undergoes a change from standard power consumption to a power consumption profile in which one or more node(s) operate in a low power mode.

In some embodiments, executing power reduction activity in accordance with the parameters of a power consumption profile includes disabling one or more components of a node. For example, the scheduler application 510 can configure a node to disable components such as processing circuitry that processes different bands or channels received by the node, active electrical components such as power amplifier(s) associated with the node, low noise amplifiers (LNAs), analog-digital converters (ADCs), digital-analog converters (DAC), communication links between DAS nodes, and other components that consume or provide power in the node (e.g., converters, power supplies, etc.). The scheduler application 510 can also enable a first node to send control signal to a second node that configures the node in accordance with the parameters of the power consumption profile as applied to that second node. In some embodiments, executing power reduction activity includes setting at least one node in a low power mode by completely disabling the node, limiting the maximum power consumption of the node, or configuring the node in a standby state. The standby state may enable the node to perform only basic DAS functions, such as communication of M-plane logs in the DAS or communication of heartbeat messaging for certain connectivity protocols, while disabling functions related to receiving, processing, and communicating control-plane and user-plane data. In some embodiments, the power can be gradually reduced in a node before entering a low power state. For example, the transmit RF power of the node can be gradually reduced, and, once the transmit RF power reaches a defined level, the node (or a component such as a power amplifier) is then set to a low-power state. Doing so can enable the node to perform any functions necessary to transition from a state of standard operation to a limited power state, such as handover functions to handover user equipment serviced by the node to other active nodes in the DAS.

FIG. 7 depicts a flow diagram of a method for selecting a power consumption profile between conflicting parameters of multiple power consumption profiles. The functions performed in method 700 can be combined with the functions described in method 600 in conjunction with the DAS described with respect to FIGS. 1-5.

Method 700 includes analyzing parameters of a plurality of power consumption profiles for a distributed antenna system at block 702. As previously noted, in some embodiments multiple power consumption profiles may be active in a DAS at any given time. Additionally, a node in the DAS may be subjected to multiple power consumption profiles, which can be recurring at a set time period and may overlap. Example parameters that can be analyzed include the duration of a power consumption profile, the operating power restrictions on one or more nodes of a power consumption profile, the functionality enabled for one or more nodes of a power consumption profile, and other parameters defined for a power consumption profile.

Method 700 then proceeds to block 704 and determines whether there is a conflict between parameters of two (or more) defined power consumption profiles. For example, at this step method 700 can determine whether there is a material disagreement between the parameters defined by one power consumption profile relative to another power consumption profile, which may occur when both power consumption profiles are active or once both power consumption profiles have been defined by scheduler application 510. In one example, if one power consumption profile (Profile A) is defined to have a remote unit disabled for a recurring time period, but a second power consumption profile (Profile B) is later defined to have the remote unit active for at least a portion of the time period allotted to Profile A (e.g., for a special event hosted at the location in which the DAS 100 is deployed), then a conflict arises with respect to the functionality of the remote unit defined by both power consumption profiles.

If method 700 detects no conflict between two or more power consumption profiles at block 704, then at block 716 method 700 proceeds by operating each node according to the parameters of each power consumption profile. In some embodiments, method 700 operates each node by executing power reduction activity for one or more nodes if the parameters of a power consumption profile restrict the operating power of the given node(s).

Conversely, if method 700 determines that a conflict exists between two or more power consumption profiles, method 700 undergoes a resolution process to select the power consumption profile best suited for DAS operation. The resolution process can be initiated and performed in an automated fashion, i.e., without additional user input, once a plurality of power consumption profiles have been defined via scheduler application 510.

From block 704, method 700 determines one or more priority criteria at block 706. In some embodiments, the priority criteria comprise a set of priority rules that favor certain types of power consumption profiles over others. One priority criterion can include the time period in which the power consumption profiles conflict with each other. For example, for a time period in which it is less likely the DAS will experience high traffic, priority may be given to the power consumption profile that reduces power consumption in the DAS, and vise-versa. Another example of a priority criterion is whether the power consumption profile is a recurring profile that is executed for a repeated time (e.g., daily, weekly, monthly), or is a profile that is only defined for one instance. In this example, a power consumption profile defined for a single occurrence can be assigned higher priority than a recurring power consumption profile, since a singular power consumption profile likely corresponds to a special event in which maximum DAS functionality is needed. Another priority criterion that can be used is the amount (or distribution) of power consumption in the DAS. Generally, it may be more preferential to have the DAS consume less power as opposed to more power in order to reduce costs; however, in some embodiments it may be more preferential to favor a power consumption profile with more power consumption in order to ensure that the capacity needs of the DAS are met. Power distribution of different nodes in the DAS can also be considered based on whether most power consumption is concentrated in one node of the DAS or is distributed across many nodes. Other priority criteria can be used.

Proceeding to block 708, method 700 scores each power consumption profile in conflict based on the priority criteria. In some embodiments, machine learning techniques using artificial intelligence can be implemented to assign respective weights to each of the priority criteria, and applies each of the applicable criteria and weight to the power consumption profiles. Method 700 then selects the highest scored power consumption profile at block 710. At block 712, method 700 operates each node according to the parameters of the selected power consumption profile. In some embodiments, a lower ranked power consumption profile may be operated concurrently with the higher ranked power consumption profile to the extent it can govern power consumption without conflicting with the higher ranked power consumption profile. For example, if a higher ranked power consumption profile demands that a group of remote units be set to a low power state and a lower ranked power consumption profile enables a portion of that group to operate in a normal power state, then the lower ranked power consumption profile can continue to be active subject to the portion of remote units governed by both power consumption profiles set to a low power state (as set by the higher ranked power consumption profile). In this example, the scheduler application 510 can remove the conflicting parameters of the lower ranked power consumption profile and keep the remaining parameters of the lower ranked power consumption profile active. In some embodiments, the lower ranked power consumption profile is temporarily (or permanently) deactivated so that nodes of the DAS are not operated according to the parameters of the lower ranked power consumption profile.

Optionally, method 700 proceeds to block 714 and sends an alarm to an administrator or other management entity of the DAS 100. For example, if the scheduler application 510 is hosted on node such as a remote unit, the scheduler application 510 can configure the remote unit to send a message to a management entity such as a system controller or other controlling node such as a master unit that a conflict has been detected between two or more power consumption profiles. In some embodiments, the alarm can include an indication that one power consumption profile has been selected over another power consumption profile. An alarm can also be sent to a remote electronic device operated by a user.

FIG. 8 depicts a flow diagram of a method for executing a power consumption profile for at least one node of a distributed antenna system, as described in one or more embodiments. The functions performed in method 800 can be combined with the functions described in methods 600-700 in conjunction with the DAS described with respect to FIGS. 1-5. For example, method 800 can be performed by a scheduler application 510 hosted by one or more nodes of the DAS once a power consumption profile has been defined.

Method 800 includes determining whether one or more conditions associated with a power consumption profile have been triggered at block 802. For example, if a power consumption profile is defined for a specific time period, then the power consumption profile is triggered when the initial time begins. If multiple conditions must be met for a power consumption profile to be triggered, then the power consumption profile is activated when each condition is met. If not all conditions associated with a power consumption profile have been triggered at block 802, then method 800 proceeds to block 804 and operates each node in a normal power mode.

If method 800 determines to activate a power consumption profile at block 802, then method 800 undergoes an execution process to determine how to configure the nodes based on the parameters defined by the power consumption profile. In the flow diagram of FIG. 8, the power consumption profile is assumed for pedagogical explanation to be one that reduces power consumption for one or more nodes in the DAS. For example, method 800 proceeds to block 806 and determines whether there is a time parameter associated with the power consumption profile, e.g., a time period in which the power consumption profile remains in effect. If there is a time parameter, then method 800 proceeds from block 806 to block 808 and configures the node(s) in a low power mode for the specified time(s). If there is no time parameter associated with the power consumption profile (e.g., it is a low priority power consumption profile that generally remains in effect until a higher priority power consumption profile is activated), then method 800 proceeds from block 806 directly to block 810. If there is a time parameter, then method 800 proceeds to block 810 from block 808.

At block 810, method 800 determines whether there is a power threshold limit of one or more nodes for the given power consumption profile. If there is a defined limit (a maximum of 25% operating parameter for the node(s)) or a power range (e.g. that the node must operate between 10% to 25% of maximum power), then method 800 configures each node to operate at or below the power threshold at block 812. If there is no power threshold limit associated with the power consumption profile, then method 800 proceeds directly from block 810 to block 814; otherwise, method 800 proceeds to block 814 from block 812.

Proceeding to block 814, method 800 determines whether the power consumption profile restricts usage of any components in the node. Such components can include circuitry for performing DAS functions (e.g., converters, processors) and components that require significant power consumption to function (most notably power amplifiers). If the power consumption profile requires certain components of the node to be disabled, then method 800 proceeds to block 816 and disables the restricted components of the node required by the power consumption profile. If there were restricted components associated with the power consumption profile, then method 800 proceeds directly from block 814 to block 818; otherwise, method 800 proceeds to block 818 from block 816.

Next, method 800 determines at block 818 whether there is any low traffic activity detected for one or more carriers utilizing the DAS. Such activity can be detected by monitoring for user-plane signals to be transmitted via one or more signal paths, one or more bands, or one or more channels that are provided to the node. If the activity in the DAS is sufficiently low (e.g., the activity is below desired thresholds), then under the power consumption profile, one or more signal paths, bands, and/or channels can be disabled for one or more nodes at block 820. For example, the DAS 100 can determine which signal path(s), band(s), and channel(s) to disable in a node that correspond to carriers with low traffic activity. In some embodiments, selected signal path(s), band(s), and/or channel(s) are automatically disabled upon activating the power consumption profile, which can be implemented when it is likely that the DAS 100 will not be utilized. If signal paths, bands, and/or channels were disabled, then method 800 proceeds from block 820 to block 822; otherwise, method 800 proceeds directly to block 822 from block 818.

After proceeding to block 822, method 800 determines whether there is any transitory activity needed to wind down operations before powering down one or more nodes of the DAS 100. For example, if there is low traffic activity but there are some user equipment being serviced by one or more nodes, then at block 824, a handover process can be performed to switch the user equipment to be serviced by other nodes of the DAS before setting some nodes to a low power state. Other functions can also be performed. Method 800 then continues to operate each node of the DAS 100 in accordance with the parameters of the power consumption profile.

While FIG. 8 depicts one example of executing at least one power consumption profile, the execution of a power consumption profile can be executed in other ways. For example, the processing associated with blocks 806-822 can be executed in a different order and at least some of the processing associated with these blocks can be executed in parallel. Additionally, the execution of a power consumption profile may include other processing not specifically shown in FIG. 8, dependent on the scope and parameters of the power consumption profile that is executed.

FIG. 9 depicts a flow diagram of a method for scheduling a power consumption profile of a distributed antenna system. The functions performed in method 900 can be combined with the functions described in methods 600-800 in conjunction with the DAS described with respect to FIGS. 1-5. For example, method 900 can be performed by a scheduler application 510 hosted by one or more nodes of the DAS 100.

Method 900 includes receiving operability parameters corresponding to operation of at least one node of the DAS at block 902. The operability parameters include parameters such as the operating power levels of the node or one or more components thereof, the power state (e.g., a normal or low power state) of the node, the functions performed by the node in the context of DAS operation, the type of node, and other parameters. In some embodiments, operability parameters are defined by a user and received as part of defining one or more power consumption profiles. The operability parameters are associated with at least one selected time duration in which the power consumption profile is active, which can also be set by defining through user input what time period(s) the operability parameters of the node(s) will be scheduled for.

Proceeding to block 904, method 900 generates one or more power consumption profiles based on the operability parameters. For example, after a user has defined the operability parameters of one or more nodes in the DAS (e.g., which nodes will be disabled or rendered in a low power state), method 900 schedules a power consumption profile for the time period(s) selected by the user in which to implement the defined operability parameters, as described in the context of FIGS. 5-6. At block 906, method 900 stores each power consumption profile generated based on the operability parameters and time period(s) defined by the user. The power consumption profile can be stored in a database (which can be accessed by the user). In the case of recurring power consumption profiles, the stored data can be accessed by the scheduler application 510 in order to implement the scheduled power consumption profile for the designated time period(s).

After defining the power consumption profile, method 900 determines at block 908 whether the time parameter associated with the power consumption profile has been triggered, e.g., whether the time recorded by the scheduler application 510 is equal to or within the time interval defined for the power consumption profile. If not, method 900 proceeds to block 910 and configures the at least one node to operate in a normal power mode, that is, enables the at least one node to operate with unrestricted power consumption. Conversely, if the time parameter is triggered, method 900 proceeds from block 908 to block 912 and configures the at least one node of the DAS in accordance with the power consumption profile for the selected time parameter. For example, the scheduler application 510 can configure one or more nodes to send control signals that configure the node according to the operability parameters of the power consumption profile. Configuring the node can be as described with respect to FIGS. 5-8, such as setting the node in a low power state, disabling the node or one or more components of the node, disabling selected signal paths, bands, or channels associated with the node, and other types of power reduction activity. In some embodiments, a first node (e.g., MU 130) can control a second node (e.g., RU 106) in accordance with the power consumption profile defined for the second node. For example, if an RU 106 needs to be set to a low-power state as specified by the parameters of the power consumption profile, MU 130 manages the power consumption profile associated with RU 106 and sets RU 106 to a low-power state when necessary.

The methods and techniques described herein may be implemented in digital electronic circuitry, or with a programmable processor (for example, a special-purpose processor or a general-purpose processor such as a computer) firmware, software, or in various combinations of each. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instruction to, a data storage system, at least one input device, and at least one output device. Generally, a processor will receive instructions and data from a read-only memory and/or a random-access memory. Storage devices suitable for tangibly embodying computer program instructions and data include all forma of non-volatile memory, including by way of example semiconductor memory devices, such as erasable programmable read-only memory (EPROM), electrically erasable programmable read-only memory (EEPROM), and flash memory devices; magnetic disks such as internal hard disks and removable disks; magneto-optical disks; and the like. Any of the foregoing may be supplemented by, or incorporated in, specially-designed application specific integrated circuits (ASICs).

### Example Embodiments

Example 1 includes a distributed antenna system, comprising: at least one master unit, wherein the at least one master unit is configured to receive downlink signals from at least one base station entity, wherein the at least one master unit is configured to generate downlink transport signals based on the downlink signals; and a plurality of remote units communicatively coupled to the at least one master unit, wherein the plurality of remote units is configured to generate downlink radio frequency (RF) signals based on the downlink transport signals, wherein the plurality of remote units is configured to radiate the downlink RF signals to user equipment in at least one coverage zone; wherein at least one node of the distributed antenna system comprises processing circuitry configured to execute power reduction activity in the distributed antenna system, wherein a first node of the at least one node is configured to: generate at least one power consumption profile in response to receiving one or more operability parameters associated with the at least one node, wherein each at least one power consumption profile governs power consumption of the at least one node according to at least one time period based on the one or more operability parameters; determine whether a condition of the at least one power consumption profile has been triggered; and in response to determining that the condition of the at least one power consumption profile has been triggered, configure the at least one node according to the one or more operability parameters of the at least one power consumption profile.

Example 2 includes the distributed antenna system of Example 1, wherein the at least one node includes: the at least one master unit, at least one of the plurality of remote units, an intermediate combining node, and/or an RF repeater.

Example 3 includes the distributed antenna system of any of Examples 1-2, wherein to configure the at least one node comprises setting the at least one node in a low power state, disabling the at least one node, disabling at least one component of the at least one node, disabling one or more signal paths of the at least one node, disabling one or more bands of the at least one node, disabling at least one channel of the at least one node, and/or performing a handover process to switch user equipment serviced by the at least one node to another node.

Example 4 includes the distributed antenna system of any of Examples 1-3, wherein to determine whether a condition of the at least one power consumption profile has been triggered comprises to determine a measured time corresponds to the at least one time period, wherein the first node of the at least one node is configured to execute the at least one power consumption profile for each of the at least one time period.

Example 5 includes the distributed antenna system of any of Examples 1-4, wherein the at least one power consumption profile is defined by a recurrent schedule comprising a plurality of time periods, wherein the first node of the at least one node is configured to automatically execute the at least one power consumption profile for each of the plurality of time periods.

Example 6 includes the distributed antenna system of any of Examples 1-5, wherein the at least one power consumption profile corresponds to at least one selected subset of nodes of the distributed antenna system, wherein the first node of the at least one node is configured to configure each node in the at least one selected subset according to the one or more operability parameters of the at least one power consumption profile.

Example 7 includes the distributed antenna system of any of Examples 1-6, wherein the one or more operability parameters include an operating power level of the at least one node, a power state of the at least one node, a type of the at least one node, and/or functions associated with the at least one node.

Example 8 includes the distributed antenna system of any of Examples 1-7, wherein the first node of the at least one node is configured to detect one or more conflicting parameters between a first power consumption profile and a second power consumption profile, and in response to detecting the one or more conflicting parameters, the first node of the at least one node is configured to select one of the first power consumption profile as a priority power consumption profile, and to configure the at least one node according to the one or more operability parameters of the priority power consumption profile.

Example 9 includes the distributed antenna system of Example 8, wherein the first node of the at least one node is configured to: score the first power consumption profile and the second power consumption profile based on one or more priority criteria; select the priority power consumption profile based on which of the first power consumption profile and the second power consumption profile has the highest score; and disable one or more operability parameters of which of the first power consumption profile and the second power consumption profile has the lowest score.

Example 10 includes the distributed antenna system of any of Examples 1-9, wherein the at least one node comprises a second node, wherein the first node of the at least one node is configured to control the second node of the at least one node in accordance with a power consumption profile associated with the second node.

Example 11 includes a method, comprising: receiving one or more operability parameters associated with at least one node of a distributed antenna system, wherein each at least one power consumption profile governs power consumption of at least one of the at least one node according to at least one time period based on the one or more operability parameters; generating at least one power consumption profile in response to receiving one or more operability parameters associated with the at least one node; determining whether a condition of the at least one power consumption profile has been triggered; and in response to determining that the condition of the at least one power consumption profile has been triggered, configuring the at least one node according to the one or more operability parameters of the at least one power consumption profile.

Example 12 includes the method of Example 11, wherein configuring the at least one node comprises: setting the at least one node in a low power state; disabling the at least one node; disabling at least one component of the at least one node; disabling one or more signal paths of the at least one node; disabling one or more bands of the at least one node; disabling at least one channel of the at least one node; and/or performing a handover process to switch user equipment serviced by the at least one node to another node.

Example 13 includes the method of any of Examples 11-12, wherein the at least one power consumption profile is defined by a recurrent schedule comprising a plurality of time periods, and further comprising executing the at least one power consumption profile for each of the plurality of time periods.

Example 14 includes the method of any of Examples 11-13, wherein the at least one power consumption profile corresponds to at least one selected subset of nodes of the distributed antenna system, and further comprising configuring each node in the at least one selected subset according to the one or more operability parameters of the at least one power consumption profile.

Example 15 includes the method of any of Examples 11-14, further comprising: detecting one or more conflicting parameters between a first power consumption profile and a second power consumption profile; in response to detecting the one or more conflicting parameters, selecting one of the first power consumption profile as a priority power consumption profile; and configuring each node according to the one or more operability parameters of the priority power consumption profile.

Example 16 includes the method of Example 15, further comprising: scoring the first power consumption profile and the second power consumption profile based on one or more priority criteria; selecting the priority power consumption profile based on which of the first power consumption profile and the second power consumption profile has the highest score; and disabling one or more operability parameters of which of the first power consumption profile and the second power consumption profile has the lowest score.

Example 17 includes the method of any of Examples 15-16, wherein generating at least one power consumption profile comprises: generating a first power consumption profile associated with a first operating power level for the at least one node, wherein the first power consumption profile corresponds to a first time period; generating a second power consumption profile associated with a second operating power level for the at least one node, wherein the second power consumption profile corresponds to a second time period, wherein configuring the at least one node comprises: configuring the at least one node to operate with an operating power level less than or equal to the first operating power level for the first time period; and configuring the at least one node to operate with the operating power level less than or equal to the second operating power level for the second time period.

Example 18 includes a distributed antenna system communicatively coupled to at least one base station entity, the distributed antenna system comprising: a plurality of nodes; and at least one processor coupled to or integrated in at least one of the plurality of nodes, wherein the at least one processor is configured to execute a scheduler application for executing power reduction activity in the distributed antenna system, wherein by executing the scheduler application the at least one processor is configured to: generate at least one power consumption profile in response to receiving one or more operability parameters associated with at least one node of the plurality of nodes, wherein each at least one power consumption profile governs power consumption of the at least one node according to at least one time period based on the one or more operability parameters; determine whether a condition of the at least one power consumption profile has been triggered; and in response to determining that the condition of the at least one power consumption profile has been triggered, configure the at least one node according to the one or more operability parameters of the at least one power consumption profile.

Example 19 includes the distributed antenna system of Example 18, wherein the at least one node includes: at least one master unit, at least one of a plurality of remote units, an intermediate combining node, and/or an RF repeater.

Example 20 includes the distributed antenna system of any of Examples 18-19, wherein a first node is configured to generate an alarm in response to an operating power level that is below a threshold level, wherein the at least one processor is configured to: determine whether the first node is defined by the at least one power consumption profile; in response to determining that the first node is defined by the at least one power consumption profile, determine whether the operating power level of the at least one node is at or below a power threshold defined by the at least one power consumption profile; and disable the alarm generated by the first node in response to determining that the operating power level of the at least one node is at or below the power threshold.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A distributed antenna system, comprising:
at least one master unit, wherein the at least one master unit is configured to receive downlink signals from at least one base station entity, wherein the at least one master unit is configured to generate downlink transport signals based on the downlink signals; and
a plurality of remote units communicatively coupled to the at least one master unit, wherein the plurality of remote units is configured to generate downlink radio frequency (RF) signals based on the downlink transport signals, wherein the plurality of remote units is configured to radiate the downlink RF signals to user equipment in at least one coverage zone;
wherein at least one node of the distributed antenna system comprises processing circuitry configured to execute power reduction activity in the distributed antenna system, wherein a first node of the at least one node is configured to:
generate at least one power consumption profile in response to receiving one or more operability parameters associated with the at least one node, wherein each at least one power consumption profile governs power consumption of the at least one node according to at least one time period based on the one or more operability parameters;
determine whether a condition of the at least one power consumption profile has been triggered; and
in response to determining that the condition of the at least one power consumption profile has been triggered, configure the at least one node according to the one or more operability parameters of the at least one power consumption profile.

2. The distributed antenna system of claim 1, wherein the at least one node includes: the at least one master unit, at least one of the plurality of remote units, an intermediate combining node, and/or an RF repeater.

3. The distributed antenna system of claim 1, wherein to configure the at least one node comprises setting the at least one node in a low power state, disabling the at least one node, disabling at least one component of the at least one node, disabling one or more signal paths of the at least one node, disabling one or more bands of the at least one node, disabling at least one channel of the at least one node, and/or performing a handover process to switch user equipment serviced by the at least one node to another node.

4. The distributed antenna system of claim 1, wherein to determine whether a condition of the at least one power consumption profile has been triggered comprises to determine a measured time corresponds to the at least one time period, wherein the first node of the at least one node is configured to execute the at least one power consumption profile for each of the at least one time period.

5. The distributed antenna system of claim 1, wherein the at least one power consumption profile is defined by a recurrent schedule comprising a plurality of time periods, wherein the first node of the at least one node is configured to automatically execute the at least one power consumption profile for each of the plurality of time periods.

6. The distributed antenna system of claim 1, wherein the at least one power consumption profile corresponds to at least one selected subset of nodes of the distributed antenna system, wherein the first node of the at least one node is configured to configure each node in the at least one selected subset according to the one or more operability parameters of the at least one power consumption profile.

7. The distributed antenna system of claim 1, wherein the one or more operability parameters include an operating power level of the at least one node, a power state of the at least one node, a type of the at least one node, and/or functions associated with the at least one node.

8. The distributed antenna system of claim 1, wherein the first node of the at least one node is configured to detect one or more conflicting parameters between a first power consumption profile and a second power consumption profile, and in response to detecting the one or more conflicting parameters, the first node of the at least one node is configured to select one of the first power consumption profile as a priority power consumption profile, and to configure the at least one node according to the one or more operability parameters of the priority power consumption profile.

9. The distributed antenna system of claim 8, wherein the first node of the at least one node is configured to:
score the first power consumption profile and the second power consumption profile based on one or more priority criteria;
select the priority power consumption profile based on which of the first power consumption profile and the second power consumption profile has the highest score; and
disable one or more operability parameters of which of the first power consumption profile and the second power consumption profile has the lowest score.

10. The distributed antenna system of claim 1, wherein the at least one node comprises a second node, wherein the first node of the at least one node is configured to control the second node of the at least one node in accordance with a power consumption profile associated with the second node.

11. A method, comprising:
receiving one or more operability parameters associated with at least one node of a distributed antenna system;
generating at least one power consumption profile in response to receiving one or more operability parameters associated with the at least one node, wherein each at least one power consumption profile governs power consumption of at least one of the at least one node according to at least one time period based on the one or more operability parameters;
determining whether a condition of the at least one power consumption profile has been triggered; and
in response to determining that the condition of the at least one power consumption profile has been triggered, configuring the at least one node according to the one or more operability parameters of the at least one power consumption profile.

12. The method of claim 11, wherein configuring the at least one node comprises:
setting the at least one node in a low power state;
disabling the at least one node;
disabling at least one component of the at least one node;
disabling one or more signal paths of the at least one node;
disabling one or more bands of the at least one node;
disabling at least one channel of the at least one node; and/or
performing a handover process to switch user equipment serviced by the at least one node to another node.

13. The method of claim 11, wherein the at least one power consumption profile is defined by a recurrent schedule comprising a plurality of time periods, and further comprising executing the at least one power consumption profile for each of the plurality of time periods.

14. The method of claim 11, wherein the at least one power consumption profile corresponds to at least one selected subset of nodes of the distributed antenna system, and further comprising configuring each node in the at least one selected subset according to the one or more operability parameters of the at least one power consumption profile.

15. The method of claim 11, further comprising:
detecting one or more conflicting parameters between a first power consumption profile and a second power consumption profile;
in response to detecting the one or more conflicting parameters, selecting one of the first power consumption profile as a priority power consumption profile; and
configuring each node according to the one or more operability parameters of the priority power consumption profile.

16. The method of claim 15, further comprising:
scoring the first power consumption profile and the second power consumption profile based on one or more priority criteria;
selecting the priority power consumption profile based on which of the first power consumption profile and the second power consumption profile has the highest score; and
disabling one or more operability parameters of which of the first power consumption profile and the second power consumption profile has the lowest score.

17. The method of claim 15, wherein generating at least one power consumption profile comprises:
generating a first power consumption profile associated with a first operating power level for the at least one node, wherein the first power consumption profile corresponds to a first time period;
generating a second power consumption profile associated with a second operating power level for the at least one node, wherein the second power consumption profile corresponds to a second time period,
wherein configuring the at least one node comprises:
configuring the at least one node to operate with an operating power level less than or equal to the first operating power level for the first time period; and
configuring the at least one node to operate with the operating power level less than or equal to the second operating power level for the second time period.

18. A distributed antenna system communicatively coupled to at least one base station entity, the distributed antenna system comprising:
a plurality of nodes; and
at least one processor coupled to or integrated in at least one of the plurality of nodes, wherein the at least one processor is configured to execute a scheduler application for executing power reduction activity in the distributed antenna system, wherein by executing the scheduler application the at least one processor is configured to:
generate at least one power consumption profile in response to receiving one or more operability parameters associated with at least one node of the plurality of nodes, wherein each at least one power consumption profile governs power consumption of the at least one node according to at least one time period based on the one or more operability parameters;
determine whether a condition of the at least one power consumption profile has been triggered; and
in response to determining that the condition of the at least one power consumption profile has been triggered, configure the at least one node according to the one or more operability parameters of the at least one power consumption profile.

19. The distributed antenna system of claim 18, wherein the at least one node includes: at least one master unit, at least one of a plurality of remote units, an intermediate combining node, and/or an RF repeater.

20. The distributed antenna system of claim 18, wherein a first node is configured to generate an alarm in response to an operating power level that is below a threshold level,
wherein the at least one processor is configured to:
determine whether the first node is defined by the at least one power consumption profile;
in response to determining that the first node is defined by the at least one power consumption profile, determine whether the operating power level of the at least one node is at or below a power threshold defined by the at least one power consumption profile; and
disable the alarm generated by the first node in response to determining that the operating power level of the at least one node is at or below the power threshold.
